(19) United States
(12) Patent Application Publication
(10) Pub. No.: US 2019/0188744 A1
(43) Pub. Date: Jun. 20, 2019

(54) Method and System for Fulfillment of a Reward Amount Earned by a User

(71) Applicant: Visa International Service Association, San Francisco, CA (US)

(72) Inventors: Karthikeyan Kandasamy, Fremont, CA (US); Margaret Carlene Vasquez, Leesburg, VA (US); Gregory Paul Loomis, Fremont, CA (US); Sonny Swords, Foster City, CA (US); Amrit Kumar Das, Leander, TX (US)

(21) Appl. No.: 15/845,299

(22) Filed: Dec. 18, 2017

(51) Int. Cl. G06Q 30/02

(52) U.S. Cl. CPC G06Q 30/0215; G06Q 30/0238; G06Q 30/0236

(57) ABSTRACT

A method for fulfillment of a reward amount earned by a user includes: receiving reward data associated with a rewards program of an offeror; receiving a transaction request associated with a transaction between a user and a merchant; determining whether the user qualifies for the rewards program; upon determining that the user qualifies for the rewards program determining the reward amount for the user corresponding to the rewards program; and crediting the reward amount to an account of the user. Systems for fulfillment of a reward amount earned by a user are also disclosed.

### BACKGROUND OF THE INVENTION

### Field of the Invention

This invention relates to methods and systems for fulfillment of a reward amount earned by a user.

### Description of Related Art

Rewards programs are offered by merchants, transaction service providers, issuers, and the like to consumers to increase retention and spend of the consumer. For their participation and activity in the rewards program, the consumers receive rewards, often in the form of a monetary reward. For example, a consumer enrolled in a rewards program may receive a credit of funds, such as a statement credit, to his/her loyalty account based on performing certain activities (e.g., reaching spending thresholds and the like).

Existing rewards programs, and the process of crediting consumer loyalty accounts with earned funds, are cumbersome and costly to set up. Additionally, the fulfillment can only be accomplished via a batch process, not in real time. In existing loyalty rewards programs, the offeror system credits the consumer's loyalty account in the batch process, not in real time, which causes a delay between the rewards being earned and the rewards being credited to the consumer.

### SUMMARY OF THE INVENTION

Accordingly, provided are improved methods and systems for fulfillment of a reward amount earned by a user.

According to a non-limiting embodiment or aspect, provided is a method for fulfillment of a reward amount earned by a user including: receiving, with at least one transaction processing server having a fulfillment processor, reward data associated with a rewards program of an offeror, the rewards program offering a reward amount to at least one user, and the transaction processing server is a server of a transaction service provider; receiving, with the at least one transaction processing server, a transaction request associated with a transaction between a user and a merchant system initiated with a portable financial device of the user; determining, with the at least one transaction processing server, based at least partially on the transaction request and the reward data, whether the user qualifies for the rewards program; upon determining that the user qualifies for the rewards program, determining, with the at least one transaction processing server, the reward amount for the user corresponding to the rewards program; and crediting, with the at least one transaction processing server, the reward amount to an account of the user.

In a non-limiting embodiment or aspect, the method may further include, upon determining that the user qualifies for the rewards program, debiting, with the at least one transaction processing server, the reward amount from an account of the offeror of the rewards program. The account of the user may be credited the reward amount in near real-time. The account of the user may be credited the reward amount in near real-time, and the reward amount may be debited from the account of the offeror of the rewards program after the account of the user is credited the reward amount. The offeror may be a merchant associated with the merchant system. The offeror may be an issuer of the portable financial device of the user. Upon the crediting of the reward amount to the account of the user, the reward amount may be instantaneously redeemable by the user.

According to a non-limiting embodiment or aspect, provided is a system for fulfillment of a reward amount earned by a user including: an offeror system of an offeror, the offeror system configured to communicate reward data associated with a rewards program of the offeror, the rewards program offering a reward amount to at least one user; a merchant system of a merchant, the merchant system configured to communicate a transaction request associated with a transaction between a user and the merchant system initiated with a portable financial device of the user; and a transaction processing server of a transaction service provider, the transaction processing server having a fulfillment processor and configured to: receive the reward data associated with the rewards program of the offeror; receive the transaction request from the merchant system; determine, based at least partially on the transaction request and the reward data, whether the user qualifies for the rewards program; upon determining that the user qualifies for the rewards program, determining the reward amount for the user corresponding to the rewards program; and crediting the reward amount to an account of the user.

In a non-limiting embodiment or aspect, the transaction processing server may be further configured to, upon determining that the user qualifies for the rewards program, debit the reward amount from an account of the offeror of the rewards program. The transaction processing server may be further configured to credit the account of the user the reward amount in near real-time. The transaction processing server may be further configured to credit the account of the user the reward amount in near real-time, and debit the reward amount from the account of the offeror of the rewards program after the account of the user is credited the reward amount. The offeror may be a merchant associated with the merchant system. The offeror may be an issuer of the portable financial device of the user. Upon the crediting of the reward amount to the account of the user, the reward amount may be instantaneously redeemable by the user.

According to a non-limiting embodiment or aspect, provided is a system for fulfillment of a reward amount earned by a user, having at least one transaction processing server of a transaction service provider including at least one fulfillment processor, the at least one transaction processing server programmed and/or configured to: receive reward data associated with a rewards program of an offeror, the rewards program offering a reward amount to at least one user; receive a transaction request associated with a transaction between a user and a merchant system initiated with a portable financial device of the user; determine, based at least partially on the transaction request and the reward data, whether the user qualifies for the rewards program; upon determining that the user qualifies for the rewards program, determine the reward amount for the user corresponding to the rewards program; and credit the reward amount to an account of the user.

In a non-limiting embodiment or aspect, the at least one transaction processing server may be further programmed and/or configured to, upon determining that the user qualifies for the rewards program, debit the reward amount from an account of the offeror of the rewards program. The account of the user may be credited the reward amount in near real-time. The account of the user may be credited the reward amount in near real-time, and the reward amount may be debited from the account of the offeror of the rewards program after the account of the user is credited the reward amount. The offeror may be a merchant associated with the merchant system. The offeror may be an issuer of the portable financial device of the user.

Further non-limiting embodiments or aspects are set forth in the following numbered clauses:

Clause 1: A method for fulfillment of a reward amount earned by a user comprising: receiving, with at least one transaction processing server comprising a fulfillment processor, reward data associated with a rewards program of an offeror, the rewards program offering a reward amount to at least one user, wherein the transaction processing server is a server of a transaction service provider; receiving, with the at least one transaction processing server, a transaction request associated with a transaction between a user and a merchant system initiated with a portable financial device of the user; determining, with the at least one transaction processing server, based at least partially on the transaction request and the reward data, whether the user qualifies for the rewards program; upon determining that the user qualifies for the rewards program, determining, with the at least one transaction processing server, the reward amount for the user corresponding to the rewards program; and crediting, with the at least one transaction processing server, the reward amount to an account of the user.

Clause 2: The method of clause 1, further comprising: upon determining that the user qualifies for the rewards program, debiting, with the at least one transaction processing server, the reward amount from an account of the offeror of the rewards program.

Clause 3: The method of clause 1 or 2, wherein the account of the user is credited the reward amount in near real-time.

Clause 4: The method of any of clauses 1-3, wherein the account of the user is credited the reward amount in near real-time, and the reward amount is debited from the account of the offeror of the rewards program after the account of the user is credited the reward amount.

Clause 5: The method of any of clauses 1-4, wherein the offeror is a merchant associated with the merchant system.

Clause 6: The method of any of clauses 1-5, wherein the offeror is an issuer of the portable financial device of the user.

Clause 7: The method of any of clauses 1-6, wherein, upon the crediting of the reward amount to the account of the user, the reward amount is instantaneously redeemable by the user.

Clause 8: A system for fulfillment of a reward amount earned by a user comprising: an offeror system of an offeror, the offeror system configured to communicate reward data associated with a rewards program of the offeror, the rewards program offering a reward amount to at least one user; a merchant system of a merchant, the merchant system configured to communicate a transaction request associated with a transaction between a user and the merchant system initiated with a portable financial device of the user; and a transaction processing server of a transaction service provider, the transaction processing server comprising a fulfillment processor and configured to: receive the reward data associated with the rewards program of the offeror; receive the transaction request from the merchant system; determine, based at least partially on the transaction request and the reward data, whether the user qualifies for the rewards program; upon determining that the user qualifies for the rewards program, determining the reward amount for the user corresponding to the rewards program; and crediting the reward amount to an account of the user.

Clause 9: The system of clause 8, wherein the transaction processing server is further configured to, upon determining that the user qualifies for the rewards program, debit the reward amount from an account of the offeror of the rewards program.

Clause 10: The system of clause 8 or 9, wherein the transaction processing server is further configured to credit the account of the user the reward amount in near real-time.

Clause 11: The system of any of clauses 8-10, wherein the transaction processing server is further configured to credit the account of the user the reward amount in near real-time, and debit the reward amount from the account of the offeror of the rewards program after the account of the user is credited the reward amount.

Clause 12: The system of any of clauses 8-11, wherein the offeror is a merchant associated with the merchant system.

Clause 13: The system of any of clauses 8-12, wherein the offeror is an issuer of the portable financial device of the user.

Clause 14: The system of any of clauses 8-13, wherein, upon the crediting of the reward amount to the account of the user, the reward amount is instantaneously redeemable by the user.

Clause 15: A system for fulfillment of a reward amount earned by a user, comprising at least one transaction processing server of a transaction service provider including at least one fulfillment processor, the at least one transaction processing server programmed and/or configured to: receive reward data associated with a rewards program of an offeror, the rewards program offering a reward amount to at least one user; receive a transaction request associated with a transaction between a user and a merchant system initiated with a portable financial device of the user; determine, based at least partially on the transaction request and the reward data, whether the user qualifies for the rewards program; upon determining that the user qualifies for the rewards program, determine the reward amount for the user corresponding to the rewards program; and credit the reward amount to an account of the user.

Clause 16: The system of clause 15, wherein the at least one transaction processing server is further programmed and/or configured to, upon determining that the user qualifies for the rewards program, debit the reward amount from an account of the offeror of the rewards program.

Clause 17: The system of clause 15 or 16, wherein the account of the user is credited the reward amount in near real-time.

Clause 18: The system of any of clauses 15-17, wherein the account of the user is credited the reward amount in near real-time, and the reward amount is debited from the account of the offeror of the rewards program after the account of the user is credited the reward amount.

Clause 19: The system of any of clauses 15-18, wherein the offeror is a merchant associated with the merchant system.

Clause 20: The system of any of clauses 15-19, wherein the offeror is an issuer of the portable financial device of the user.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic view of a non-limiting embodiment or aspect of a system for fulfillment of a reward amount earned by a user;

FIG. 2 is a schematic view of another non-limiting embodiment or aspect of a system for fulfillment of a reward amount earned by a user;

FIG. 3 is a schematic view of another non-limiting embodiment or aspect of a system for fulfillment of a reward amount earned by a user;

FIG. 4 is a step diagram of one non-limiting embodiment or aspect of a method for fulfillment of a reward amount earned by a user; and

FIG. 5 is a process flow diagram of one non-limiting embodiment or aspect of a method for fulfillment of a reward amount earned by a user.

### DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” or “issuer” may refer to one or more entities, such as a bank, that provide accounts to customers for conducting transactions (e.g., payment transactions), such as initiating credit and/or debit payments. For example, an issuer institution may provide an account identifier, such as a personal account number (PAN), to a customer that uniquely identifies one or more accounts associated with that customer. The account identifier may be embodied on a portable financial device, such as a physical financial instrument (e.g., a payment card, and/or may be electronic and used for electronic payments). The term “issuer system” refers to one or more computer systems operated by or on behalf of an issuer institution, such as a server computer executing one or more software applications. For example, an issuer system may include one or more issuer processor for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system”, as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “offeror” may refer to an individual or entity that offers a rewards program to provide rewards, based on consumer activity such as a discount, rebate, gift, statement credit, or other monetary reward, to encourage consumers to purchase goods and/or services. Example entities that may be an offeror include merchants and issuer institutions. The offeror system may refer to one or more computer systems operated by or on behalf of the offeror, such as a server computer executing one or more software applications. As part of the rewards program, each consumer may have a user account specific to that consumer operated by or on behalf of the offeror, and the consumer may accumulate rewards earned as part of the rewards program in the user account. For example, after the consumer performs a predetermined action that satisfies a rule of thee. rewards program (e.g., a purchase), an amount of rewards may be credited to the user account.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The term “client device”, as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the portable financial device may include volatile or non-volatile memory to store information (e.g., an account identifier, a name of the account holder, and/or the like).

The term “account data”, as used herein, refers to any data concerning one or more accounts for one or more users. Account data may include, for example, one or more account identifiers, user identifiers, transaction histories, balances, credit limits, issuer institution identifiers, and/or the like.

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system”, such as a merchant's point-of-sale system. Reference to “a server” or “a processor”, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. In other non-limiting embodiments, the computing device may be a desktop computer or other non-mobile computer. Furthermore, the term “computer” may refer to any computing device that includes the necessary components to receive, process, and output data, and normally includes a display; a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

Non-limiting embodiments or aspects of the present invention are directed to methods and systems for fulfillment of a reward amount earned by a user. Non-limiting embodiments or aspects of the methods and systems allow a user to be credited the earned reward from a rewards program in near real-time. This near real-time crediting may be achieved by a fulfillment processor of a transaction processing server of a transaction service provider crediting the reward amount to the user's account in near real-time, as opposed to the offeror system (separate from the transaction processing server transaction service provider) crediting the user account via a batch process some time period after the user has earned the reward that is not in near real-time. By arranging the system architecture such that the transaction service provider credits the user account in near real-time, the delay between the user earning the rewards and actually receiving the rewards is reduced. In non-limiting embodiments or aspects, the fulfillment processor debits the offeror system upon determining that the user qualifies for the reward. However, the present system does not delay the user being credited the reward until the fulfillment processor debits the offeror system, and, in some embodiments, the fulfillment processor debits the offeror system (maintaining a net-zero balance) after the user's account has been credited the reward. The present methods and systems may more timely and efficiently fulfill the reward amount earned by the user.

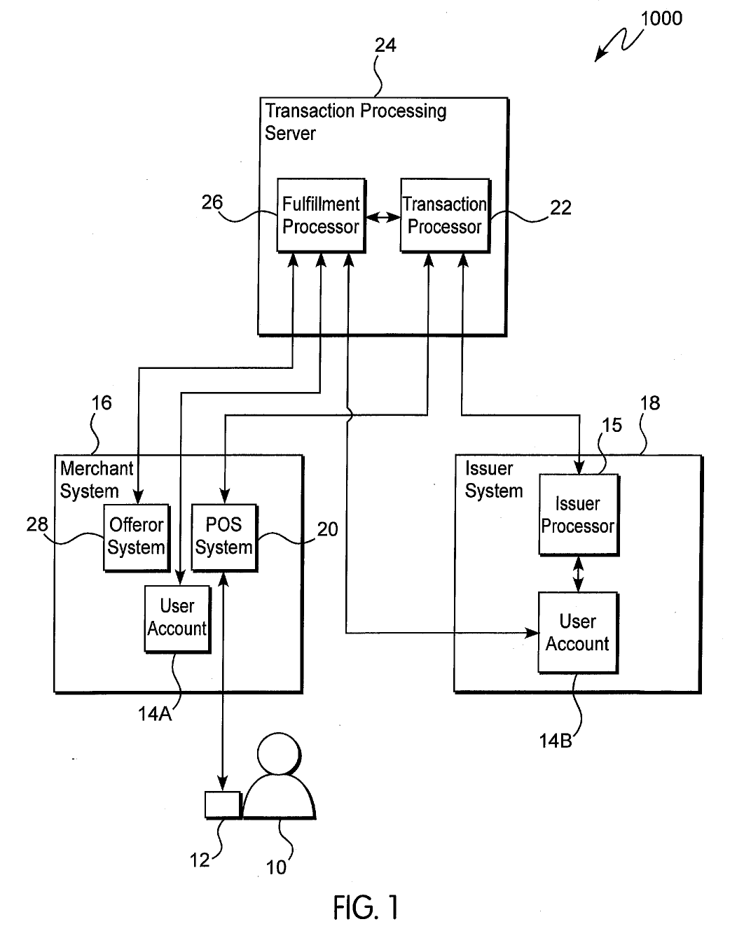

Referring to FIG. 1, a non-limiting embodiment or aspect of a system 1000 for fulfillment of a reward amount earned by a user in which the merchant is the offeror is shown. A user 10 (e.g., a consumer) may initiate a transaction (e.g., a purchase) for goods and/or services by presenting a portable financial device 12 to a merchant having a merchant system 16. A POS system 20 of the merchant may process the portable financial device 12 to begin processing the transaction. The POS system 20 may communicate a transaction request including transaction data to a transaction processor 22 of a transaction processing server 24 operated by or on behalf of a transaction service provider. The transaction data may include any information associated with the transaction between the user 10 and the merchant. For example, the transaction data may be account data. The transaction data may include, for example, a primary account number (PAN), amount of individual transaction, date of transaction, goods and services purchased, merchant identifier, merchant category code, number of transactions initiated during a time period, sum of transaction spend over a time period, and/or any other data relevant to completing the transaction and/or processing loyalty rewards associated with the transaction. The transaction processor 22 may process the transaction request and communicate with an issuer processor 15 of an issuer system 18 for further processing of the transaction, such as authorization, settlement, and clearing of the transaction.

With continued reference to FIG. 1, the user 10 may be enrolled in a rewards program offered by or on behalf of the merchant of the merchant system 16 (the merchant is the offeror). It will be appreciated that the offeror may be an entity other than the merchant, as later described. The merchant system 16 may include an offeror system 28 to facilitate management of the rewards program of the merchant. The offeror system 28 may determine the offers included in the rewards program and available to the user 10. The offeror system 28 may also transmit funds that ultimately provide the user 10 with the earned rewards. In other words, the offeror funds the rewards owed to the user 10 as part of the rewards program. The system 1000 may include a user account 14 (e.g., 14A, 14B) associated with the user, and the rewards earned by the user may be transmitted into the user account 14. The user account 14A may be a part of the merchant system 16, such that the user account 14A is operated by or on behalf of the merchant. The user account 14B may be a part of the issuer system 18, such that the user account 14B is operated by or on behalf of the issuer. However, the user account 14 may be located at other locations and operated by or on behalf of other individual or entity.

With continued reference to FIG. 1, the transaction processing server 24 may include a fulfillment processor 26. The fulfillment processor may communicate with the transaction processor 22. The transaction processor 22 may communicate at least some of the transaction data from the transaction request to the fulfillment processor 26, such as transaction data required to determine reward information. It will be appreciated that the transaction processor 22 and the fulfilment processor 26 are both processors that are part of the transaction processing server 24 of the transaction service provider. In some non-limiting embodiments, the transaction processor 22 and the fulfillment processor 26 may be separate processors, as shown in FIG. 1. In other non-limiting embodiments, the transaction processor 22 and the fulfilment processor 26 may be the same processor. In still other non-limiting embodiments, the transaction processor 22 and/or the fulfillment processor 26 shown in FIG. 1 may be broken down into further processors to perform the functions described herein, as necessary. The fulfillment processor 26 may also receive reward data from the offeror system 28. The reward data may be associated with a rewards program of the offeror. The reward data may include reward rules that specify the reward amount owed to a user based on the user's 10 activity for a specific time period. As one non-limiting example, the reward data may specify a reward rule that all users of the rewards program receive 1% cash back on all purchase made during the first calendar quarter of a given calendar year (January-March). However, it will be appreciated that any other types of rewards rules and reward data may be communicated by the offeror system 28. The reward data may also may also include an identification of users who are enrolled in the program or rules to determine if a user is enrolled in the program.

With continued reference to FIG. 1, the fulfillment processor 26 may determine, based at least partially on the transaction data from the transaction request and on the reward data from the offeror system 28, whether the user 10 qualifies for the rewards program. This may occur by the fulfillment processor 26 comparing the relevant transaction data with the relevant reward data to determine whether the user 10 has qualified for the rewards program. For example, based on the rewards rule that all users of the rewards program receive 1% cash back on all purchase made during the first calendar quarter of a given calendar year (January-March), the fulfillment processor 26 may determine the date of the transaction and the amount of the transaction, such that if the purchase is made in the January-March timeframe of the specified calendar year, the user 10 (who is included in the list of enrolled users) qualifies for the 1% cash back reward.

With continued reference to FIG. 1, upon the fulfillment processor 26 determining that the user 10 qualifies for the rewards program, the fulfillment processor 26 may determine the rewards amount for the user 10 corresponding the rewards program. Thus, the fulfillment processor 26 may determine the amount of the reward owed to the user based on the purchase if the user 10 is determined to have completed activity that makes the user 10 eligible for a reward from the rewards program.

With continued reference to FIG. 1, upon the fulfillment processor 26 determining the reward amount, the fulfillment processor 26 credits the reward amount to the user account 14. As previously discussed, the user account 14 may be an account operated by or on behalf the merchant system 16, the issuer system 18, or some other system. The fulfillment processor 26 may credit the user account 14 with the rewards amount in near real-time (at the time the reward is earned by the user 10 minus automated data processing and network transmission time). Near real-time may be considered nearly instantaneously. The rewards amount may be credited to the user account 14 in near-real time with the authorization of the transaction, such as at the authorization of the transaction at point of sale. Thus, there is almost no time delay between the time the reward amount is earned by the user 10 and the time the user account 14 is credited the rewards amount by the fulfillment processor 26. Upon the crediting of the rewards amount by the fulfillment processor 26, the reward amount may be instantaneously redeemable by the user 10.

With continued reference to FIG. 1, upon determining that the user 10 qualifies for the rewards program, the fulfillment processor 26 may debit the reward amount from an account of the offeror of the rewards program (the offeror system 28). The reward amount may be debited by the fulfillment processor 10 from the offeror system 28. In some non-limiting embodiments, the debiting of the reward amount from the offeror system 28 may occur simultaneously with crediting of the reward amount to the user account 14. In other non-limiting embodiments, the debiting of the reward amount from the offeror system 28 may occur after crediting of the reward amount to the user account 14. In these cases, the reward account may be credited to the user account 14 without delay (in near real-time), and the debiting from the offeror system 28 by the fulfillment processor 26 may occur later so as to not delay crediting of the reward amount to the user 10. In some examples, the fulfillment processor 26 debits the offeror system 28 after a time period, such as at the end of a business day, week, month, quarter, year, and the like. The fulfillment processor 26 may debit the offeror system 28 via a continuous process or a batch process. The fulfillment processor 26 may debit the offeror system 28 the reward amount so as to maintain a net-zero balance. In other words, the fulfillment processor 26 may credit the reward amount to the user account 14 and debit the same reward amount from the offeror system 28 at the same time or at a later time so that the offeror system 28 ultimately funds the reward amount. By the fulfillment processor 26 crediting the user account 14, the crediting can be performed in near real-time to benefit the user, and the fulfillment processor 26 and offeror system 28 may settle the reward amount at the same time or at a later time period so as not to delay crediting of the reward. Therefore, the present system 1000 may more timely and efficiently fulfill the reward amount earned by the user 10.

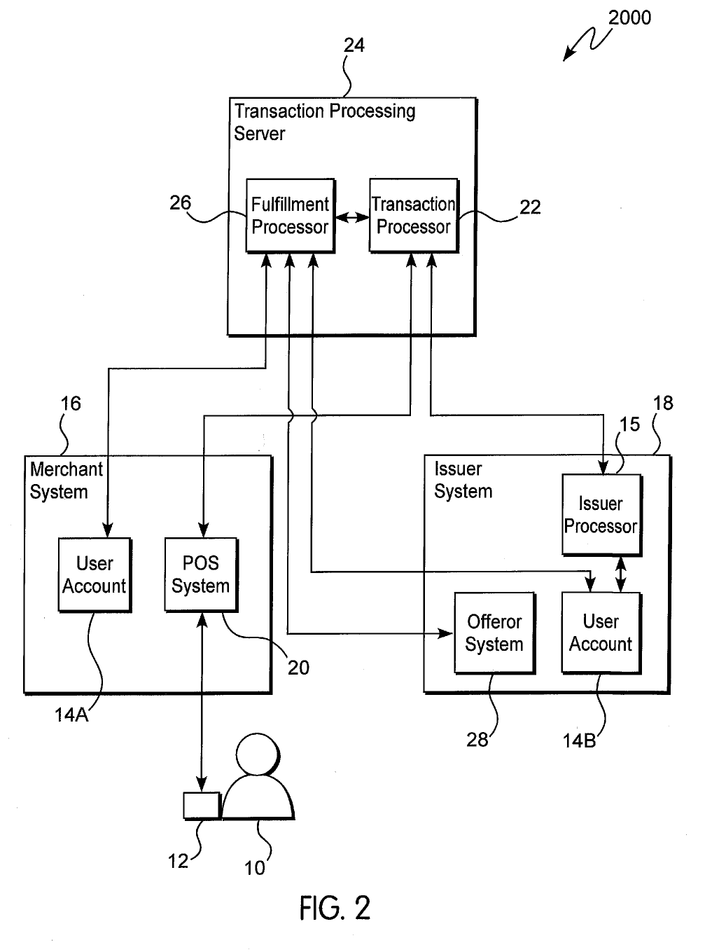

Referring to FIG. 2, a non-limiting embodiment or aspect of a system 2000 for fulfillment of a reward amount earned by the user 10 in which the issuer is the offeror is shown. The system 2000 shown in FIG. 2 is the same as the system 1000 shown in FIG. 1 except for the issuer being the offeror. Because of this difference, the issuer system 18 includes the offeror system 28 (and not the merchant system 16) to facilitate management of the rewards program of the issuer. The offeror system 28 includes all of the same capabilities as previously described. In the system of FIG. 2, the issuer is the ultimate funding entity of the reward amount to the user account (by the fulfillment processor 26 debiting the reward amount from the offeror system 28).

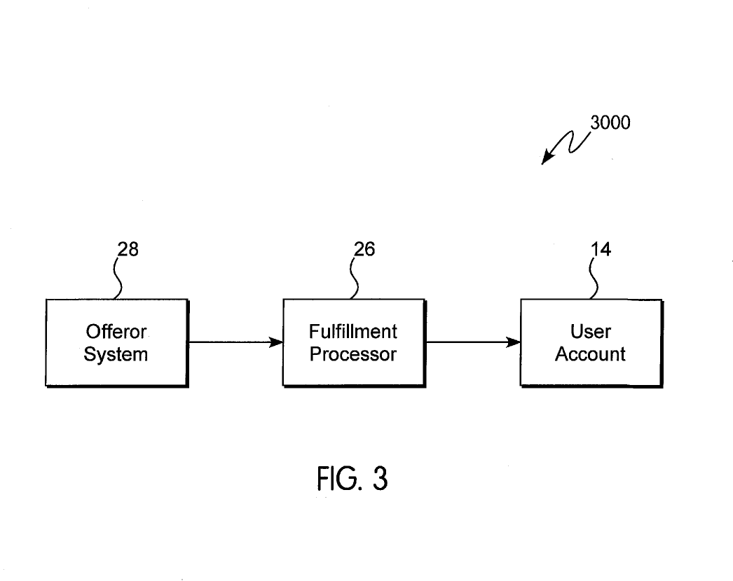

Referring to FIG. 3, a non-limiting embodiment or aspect of a system 3000 for fulfillment of a reward amount earned by a user, and, specifically, the flow of funds to fulfill the reward amount owed to the user is shown. Upon the fulfillment processor 26 determining that the user qualifies for the rewards program and determining the reward amount owed to the user, the fulfillment processor 26 credits the reward amount to the user account 14. This may be performed by the fulfillment processor 26 transmitting funds to the user account 14, such as via an original credit transaction (OCT). The payment of funds from the fulfillment processor 26 to the user account 14 may be a push payment. The payment of funds from the fulfillment processor 26 to the user account 14 may occur in near real-time as previously described. The fulfillment processor 26 may debit the offeror system 28 at the time previously described (simultaneously with crediting the user account 14) or after the user account 14 has already been credited). The fulfillment processor 26 may pull the funds for the reward amount from the offeror system 28, or the offeror system 28 may push the funds to the fulfillment processor 26.

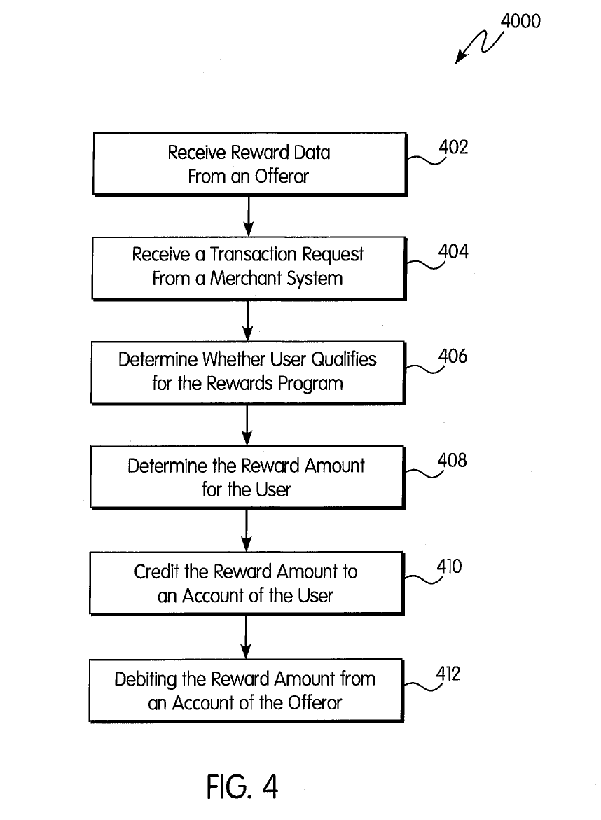

Referring to FIG. 4, a non-limiting embodiment or aspect of a method 4000 for fulfillment of a reward amount earned by a user is shown. At a step 402, the transaction processing server 24, such as the fulfillment processor 26 thereof, may receive the previously described reward data from an offeror system 28. At a step 404, the transaction processing server 24, such as the transaction processor 22 thereof, may receive a transaction request from the merchant system 16, the transaction request associated with a transaction between a user and the merchant system 16 that was initiated by a portable financial device of the user. The transaction request may include transaction data. The fulfillment processor 26 may receive at least some of the transaction data in the transaction request.

At a step 406, the fulfillment processor 26 may determine whether the user qualifies for the rewards program. This determination may be made based at least partially on the transaction request (transaction data therefrom) and the reward data. At a step 408, upon determining that the user qualifies for the rewards program, the fulfillment processor 26 may determine the reward amount for the user corresponding to the rewards program. At a step 410, the fulfillment processor 26 may credit the reward amount to the user account of the user. At a step 412, the fulfillment process may debit the reward amount from the offeror system 28 (an account of the offeror which is a part of the offeror system 28).

The following example is provided to illustrate an embodiment of the system and method for fulfillment of a reward amount earned by a user, and is not meant to be limiting.

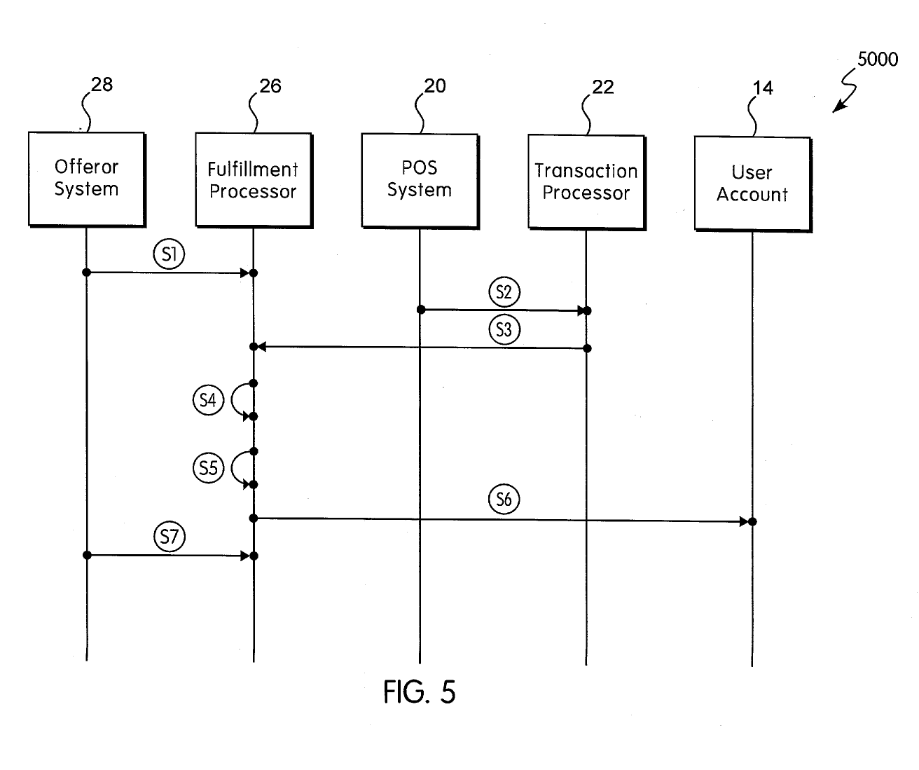

Referring to FIG. 5, a non-limiting embodiment or aspect of a method for fulfillment of a reward amount earned by a user is shown. In this example, a consumer (e.g., Frank Clark) is the holder of a portable financial device (e.g., First Credit Card). The transaction service provider for First Credit Card is TSP, and the issuer of First Credit Card is The Issuer Bank. TSP has a transaction processing server that includes at least two processors (the fulfillment processor 26 and the transaction processor 22). In other examples, the fulfillment processor 26 and the transaction processor 22 are the same processor.

In this example, Frank Clark is enrolled in a rewards program called “Spend” offered by The Issuer Bank. Thus, The Issuer Bank is the offeror of Spend (like the system architecture shown in FIG. 2). This example is not meant to be limiting, and the rewards program may be offered by another entity such as a merchant. The Issuer Bank has an offeror system 28 for facilitating the implementation of Spend.

At a first step (s1), the offeror system 28 communicates reward data associated with the rewards program of The Issuer Bank to the fulfillment processor 26. The reward data includes rewards rules that govern Spend, including when a consumer is eligible for a reward (e.g., which activities of the consumer trigger a reward) and how to determine the reward amount. In this Example, the rewards rules of Spend dictate that any user enrolled in the program is eligible for 1% cash back on all purchase made during the first calendar quarter of a given calendar year (January-March). Frank Clark is enrolled in Spend, which information is communicated to the fulfillment processor 26 by the offeror system 28.

At a second step (s2), Frank Clark initiates a transaction on January 14th for a hamburger at Slow Foods (a restaurant) by presenting First Credit Card to the POS system 20 of Slow Foods. The hamburger costs $5.00. The POS system communicates a transaction request including the relevant transaction data (as previously described) to the transaction processor 22 of TSP. The transaction processor 22 processes the transaction in order to authorize, settle, and clear the transaction. The transaction processor 22 also communicates at least some of the transaction data of the transaction request to the fulfillment processor 26, as shown in a third step (s3). In this example, the transaction processor 22 at least communicates the following information to the fulfillment processor 26: date of the transaction, and amount of the transaction.

At a fourth step (s4), the fulfillment processor 26 determines, based at least partially on the transaction request and the reward data, whether Frank Clark qualifies for the rewards program based on his purchase at Slow Foods. The fulfillment processor 26 determines that the purchase occurred in January (the first quarter of the applicable calendar year) based on the data from the transaction request. The fulfillment processor 26 determines that Frank Clark is enrolled in Spend based on the reward data. Thus, the fulfillment processor determines that Frank Clark qualifies for a reward based on Spend because of his purchase at Slow Foods.

At a fifth step (s5), upon determining that Frank Clark qualifies for the rewards program, the fulfillment processor 26 determines the reward amount associated with his purchase slow foods. Based on the rule that the reward is a 1% cash back on all purchases and the transaction data in the transaction request that the purchase amounted to $5.00, the fulfillment processor 26 determines that the reward amount for Frank Clark for Spend is $0.05.

At a sixth step (s6), the fulfillment processor 26 credits the user account 14 of Frank Clark $0.05 as the reward for his purchase at Slow Foods. The fulfillment processor 26 credits the user account 14 of Frank Clark in near real-time such that the rewards amount is credited to his account nearly instantaneously after it has been determined that Frank Clark earned the reward amount. Once the reward amount has been credited to the user account 14 of Frank Clark, it is available for him to redeem immediately.

At a seventh step (s7), the fulfillment processor 26 debits the offeror system $0.05 (the rewards amount). The fulfillment processor 26 debits the offeror system at the end of the day on January 14th (after Frank Clark's user account 14 has already been credited).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is

1. A method for fulfillment of a reward amount earned by a user comprising:
receiving, with at least one transaction processing server comprising a fulfillment processor, reward data associated with a rewards program of an offeror, the rewards program offering a reward amount to at least one user, wherein the transaction processing server is a server of a transaction service provider;
receiving, with the at least one transaction processing server, a transaction request associated with a transaction between a user and a merchant system initiated with a portable financial device of the user;
determining, with the at least one transaction processing server, based at least partially on the transaction request and the reward data, whether the user qualifies for the rewards program;
upon determining that the user qualifies for the rewards program, determining, with the at least one transaction processing server, the reward amount for the user corresponding to the rewards program; and
crediting, with the at least one transaction processing server, the reward amount to an account of the user.

2. The method of claim 1, further comprising:
upon determining that the user qualifies for the rewards program, debiting, with the at least one transaction processing server, the reward amount from an account of the offeror of the rewards program.

3. The method of claim 1, wherein the account of the user is credited the reward amount in near real-time.

4. The method of claim 2, wherein the account of the user is credited the reward amount in near real-time, and the reward amount is debited from the account of the offeror of the rewards program after the account of the user is credited the reward amount.

5. The method of claim 1, wherein the offeror is a merchant associated with the merchant system.

6. The method of claim 1, wherein the offeror is an issuer of the portable financial device of the user.

7. The method of claim 1, wherein, upon the crediting of the reward amount to the account of the user, the reward amount is instantaneously redeemable by the user.

8. A system for fulfillment of a reward amount earned by a user comprising:
an offeror system of an offeror, the offeror system configured to communicate reward data associated with a rewards program of the offeror, the rewards program offering a reward amount to at least one user;
a merchant system of a merchant, the merchant system configured to communicate a transaction request associated with a transaction between a user and the merchant system initiated with a portable financial device of the user; and
a transaction processing server of a transaction service provider, the transaction processing server comprising a fulfillment processor and configured to:
receive the reward data associated with the rewards program of the offeror;
receive the transaction request from the merchant system;
determine, based at least partially on the transaction request and the reward data, whether the user qualifies for the rewards program;
upon determining that the user qualifies for the rewards program, determining the reward amount for the user corresponding to the rewards program; and
crediting the reward amount to an account of the user.

9. The system of claim 8, wherein the transaction processing server is further configured to, upon determining that the user qualifies for the rewards program, debit the reward amount from an account of the offeror of the rewards program.

10. The system of claim 8, wherein the transaction processing server is further configured to credit the account of the user the reward amount in near real-time.

11. The system of claim 9, wherein the transaction processing server is further configured to credit the account of the user the reward amount in near real-time, and debit the reward amount from the account of the offeror of the rewards program after the account of the user is credited the reward amount.

12. The system of claim of claim 8, wherein the offeror is a merchant associated with the merchant system.

13. The system of claim of claim 8, wherein the offeror is an issuer of the portable financial device of the user.

14. The system of claim 8, wherein, upon the crediting of the reward amount to the account of the user, the reward amount is instantaneously redeemable by the user.

15. A system for fulfillment of a reward amount earned by a user, comprising at least one transaction processing server of a transaction service provider including at least one fulfillment processor, the at least one transaction processing server programmed and/or configured to:
receive reward data associated with a rewards program of an offeror, the rewards program offering a reward amount to at least one user;
receive a transaction request associated with a transaction between a user and a merchant system initiated with a portable financial device of the user;
determine, based at least partially on the transaction request and the reward data, whether the user qualifies for the rewards program;
upon determining that the user qualifies for the rewards program, determine the reward amount for the user corresponding to the rewards program; and
credit the reward amount to an account of the user.

16. The system of claim 15, wherein the at least one transaction processing server is further programmed and/or configured to, upon determining that the user qualifies for the rewards program, debit the reward amount from an account of the offeror of the rewards program.

17. The system of claim 15, wherein the account of the user is credited the reward amount in near real-time.

18. The system of claim 16, wherein the account of the user is credited the reward amount in near real-time, and the reward amount is debited from the account of the offeror of the rewards program after the account of the user is credited the reward amount.

19. The system of claim 15, wherein the offeror is a merchant associated with the merchant system.

20. The system of claim 15, wherein the offeror is an issuer of the portable financial device of the user.
